(19) United States
(12) Patent Application Publication
(10) Pub. No.: US 2006/0265932 A1
(43) Pub. Date: Nov. 30, 2006

(54) Electric voltage generating fishing lure

(76) Inventor: Bret L. Davis, Badger, IA (US)

Correspondence Address: Warren Alexander Reiter, 150 North Clark St., Forest City, IA, 50436, US

(21) Appl. No.: 11/138,929

(22) Filed: May 25, 2005

(51) Int. Cl. A01K 85/01

(52) U.S. Cl. 43/17.1

(57) ABSTRACT

An apparatus for attracting fish by means of generating an electric voltage that mimics the natural voltage emitted by the movement of baitfish. Passing a ferrous magnet back and forth through a coil of wire generates the electric voltage. The movement of the lure in the water creates the motion of the magnet, thus generating and transmitting voltage to the water via the lure hook eyelets.

### FEDERALLY SPONSORED RESEARCH

Not Applicable

### SEQUENCE LISTING OR PROGRAM

Not Applicable

### BACKGROUND

1. Field of Invention

The present invention relates to fishing lures, more particularly lures that generate an electric voltage. Even more particularly, the present invention relates to fishing lures that are completely self-contained that mimic the electric voltage produced by baitfish. Most baitfish produce an electric voltage of approximately between 0.000 and 0.010 volts when swimming. The current invention uses a simple wire coil and magnet to produce this desired effect that attracts game fish.

2. Description of Prior Art

Fishermen use lures in attempt to attract fish while fishing. Various electrical lures have been tried in an effort to enhance the attractiveness of these fishing lures to game fish.

U.S. Pat. No. 6,457,275 to Spurgeon does an excellent job describing the previous methods and their limitations and drawbacks. This patent describes patents that attract fish by using electric lures that use light as disclosed in U.S. Pat. No. 4,227,331 to Ursrey; U.S. Pat. No. 5,159,773 to Scott; and U.S. Pat. No. 5,495,690 to Hunt. Other electric lures to generate sound as disclosed in U.S. Pat. No. 4,583,313 to Dugan and movement as disclosed in U.S. Pat. No. 6,807,766 to Hughes and U.S. Pat No. 6,647,659 to King. As noted in Spurgeon, these methods have several problems including most use batteries and microcontrollers which are unnecessarily heavy and subject to failure due to power depletion and short circuiting in the aqueous atmosphere.

Spurgeon patent describes an electric voltage generating fishing lure attachment. The fishing lure has rigid sealed tube with a movable weight and its movement is limited by the tube's wall. Piezoelectric crystals are attached to the ends of the tube. The shock resulting between weight and the end walls is transmitted to the piezoelectric crystals generating an electric voltage. The electric voltage that is generated is conducted to the surrounding aqueous atmosphere by an electric conducting container or by having the crystal in direct contact with the aqueous environment. This patent describes an attachment that might become detached from the fishing lure.

U.S. Pat No. 5,903,999 to Petras describes another electric voltage generating fishing lure. In Petras, the electric voltage is generated by having the two body portions made of different metals and being movable with respect to each other, again the electric voltage generator is exposed directly to the aqueous environment.

While the last two prior art devices considered above generate an electric voltage surrounding the fishing lure for attracting fish, which is the subject of the present invention. The apparatus and method employed by the present invention depart from the conventional concepts and designs taught by the prior art. In doing so, the present invention provides a method creating an electric voltage for the purpose of attracting fish as describe by the above two patents, but it accomplishes the result in a different and improved manner. The current invention is fully enclosed to prevent damage by the aqueous environment and generates its electric voltage in a much more simple and easy manner of control.

### SUMMARY OF THE INVENTION

In view of the foregoing described and other disadvantages inherent in the known types of electrically activated fishing lures presently existing in the prior art, the present invention provides a new voltage generating lure to attract fish with various types of lures. The general purpose of the present invention is to provide a new electronic fishing lure that has the advantages of other fishing lures without the major disadvantage of weight, complex design, and being open to the aqueous environment.

More particularly, the present invention is an electric voltage generator enclosed inside a fishing lure for attracting fish. It is comprised of a typical and ordinary fishing lure that has a hollowed out body cavity. A coil of wire is placed in the hollowed body cavity. Inside the coil of wire a magnetic is placed and as the magnet moves inside the coil of wire as the lure is moved from side to side or up and down. As the magnet moves inside the coil of wire, a voltage is induced. The voltage that is generated is conducted to the aqueous environment via the hook or line eyelets leaving the voltage generating portion of the lure isolated from the aqueous environment.

These and other advantages and novel features of the present invention, as well as details of an illustrated embodiment thereof, will be more fully understood from the following description and drawings.

### BRIEF DESCRIPTION OF THE DRAWINGS

### DRAWING FIGURES

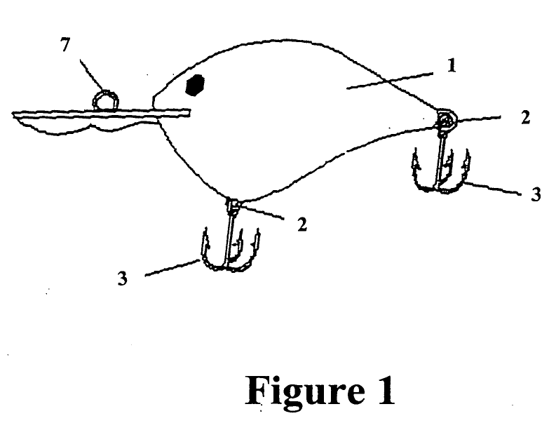

FIG. 1 is a perspective view of the preferred embodiment of the apparatus of the present invention.

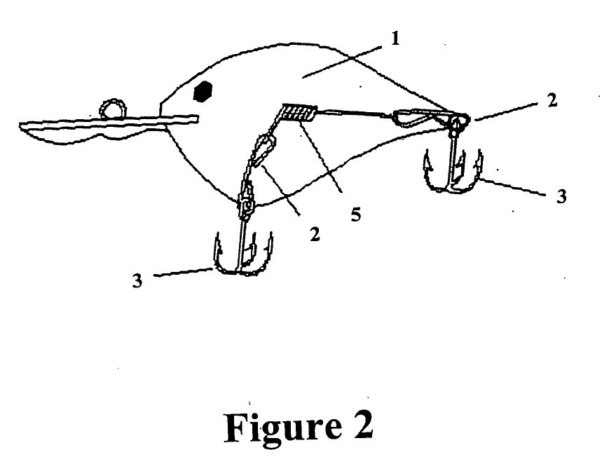

FIG. 2 is cutaway perspective view of the preferred embodiment of the apparatus of the present invention.

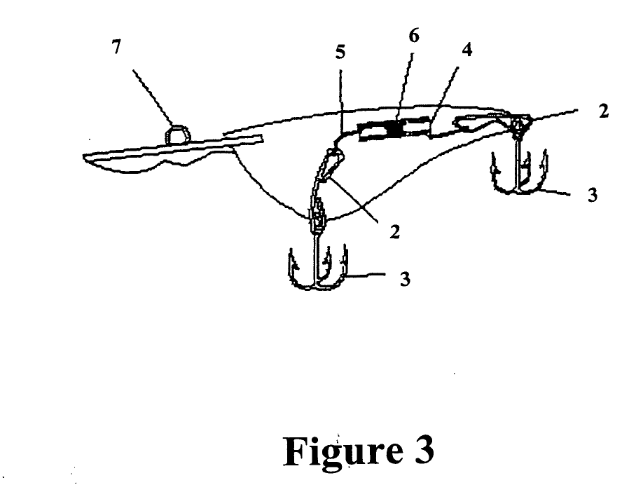

FIG. 3 is a cross-sectional view of the cutaway perspective view of the preferred embodiment of the apparatus of the present invention.

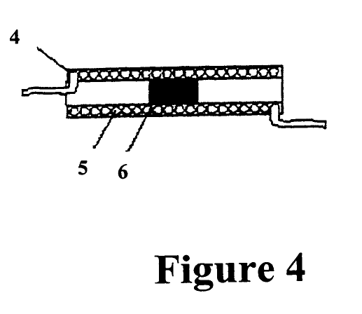

FIG. 4 is cutaway perspective view of electric voltage generator of the preferred embodiment of the apparatus of the present invention.

### DETAILED DESCRIPTION OF THE PREFERRED EMBODIMENT

FIGS. 1-4 show an electronic fishing lure as contemplated by the present invention. The lure is comprised of a body portion 1 that can be attached to a fishing line through a line eyelet 7 on the front-end of the lure. One or more hooks can be attached to the hook eyelets 2. The body portion is formed to oscillate, partially rotate, or bob in the water while being towed by a fishing line.

FIG. 1 and FIG. 2 shows the major advantage of this invention namely the electric voltage generator of the fishing lure is a simple and easy to construct design and is fully self-contained within the lure.

FIG. 4 shows the voltage generator that is comprised of a spool 4 that has wire 5 coiled around the spool. Inside the spool, a magnet 6 is allowed to move within the spool as the lure is moved through the water. As the magnet moves within the coiled wire a voltage is induced on the coil. The induced voltage is conducted to the water through hook eyelets 2 or alternatively maybe accomplished through the line eyelet, see FIG. 3. By allowing the voltage to be conducted to the water via the hook or line eyelets the voltage generator is completely sealed from the aqueous environment.

In the preferred embodiment the coil is made of copper wire, any appropriate type of wire maybe used, and the amount of wire and the strength of the magnet is controlled to allow for proper weighting of the lure but are used in such a combination that the voltage is controlled between 0.0 to 0.010 volts as the magnetic moves through the spool. The preferred voltage is 0.05 volts.

In view of the above detailed description of the present invention and associated drawings, other modifications and variations will now become apparent to those skilled in the art. It should be apparent that such other modifications and variations might be effected without departing from the spirit and scope of the present invention.

I claim:

1. An electric voltage generator that is fully enclosed within a fishing lure with hook and line eyelets for attracting fish comprised of a coil wire and a magnet that is allowed to move longitudinally through said coil of wire and where the resulting voltage is transferred to the aqueous environment so that voltage will attract fish.

2. The electric voltage generator in claim 1 where the resulting voltage is transferred to the aqueous environment via the hook or line eyelets.

3. The electric voltage generator in claim 1 where the coil of wire is made of copper wire.

4. The electric voltage generator in claim 1 where the resulting voltage is controlled between 0.00 and 0.010 volts.

5. An electric voltage generator that is fully enclosed within a fishing lure with hook and line eyelets for attracting fish comprised of a spool with a coil of wire around said spool and a magnet that is allowed to move longitudinally through said spool and coil of wire and where the resulting voltage is transferred to the aqueous environment so that voltage will attract fish.

6. The electric voltage generator in claim 5 where the resulting voltage is transferred to the aqueous environment via the hook or line eyelets.

7. The electric voltage generator in claim 5 where the coil of wire is made of copper wire.

8. The electric voltage generator in claim 5 where the resulting voltage is controlled between 0.00 and 0.010 volts.

9. An electric voltage generator that is fully enclosed within a fishing lure with hook and line eyelets for attracting fish comprised of a spool with a coil of wire said wire made of copper and is wrapped around said spool and a magnet that is allowed to move longitudinally through said spool and coil of wire and where the resulting voltage is transferred to the aqueous environment so that voltage will attract fish and the resulting voltage is controlled between 0.00 and 0.010 volts and said resulting voltage is transferred to the aqueous environment via the hook or line eyelets.
